(19) United States
(12) Patent Application Publication
(10) Pub. No.: US 2008/0106474 A1
(43) Pub. Date: May 8, 2008

(54) Device Comprising An Antenna For Exchanging Radio Frequency Signals

(75) Inventor: Anthony Kerselaers, Leuven (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/720,521

(22) PCT Filed: Nov. 29, 2005
(86) PCT No.: PCT/IB05/53952

§ 371 Date: May 31, 2007

(30) Foreign Application Priority Data
Dec. 6, 2004 (EP) 04106327.2

(51) Int. Cl. H01Q 9/04

(52) U.S. Cl. 343/700 MS

(57) ABSTRACT

In devices (1) comprising antennas (2) for exchanging radio frequency signals, the antennas (2) comprise two conductive planes (21,22) which comprise two connection points (31a,32a) and which are separated by gaps (23) for separating the conductive planes (21,22) from each other and which are coupled to each other by conductive bridges (24). These antennas (2) have a sufficient antenna performance, do not require power amplifiers to be over dimensioned, do not introduce extra power consumption, have sufficient bandwidth, are low cost and can easily be manufactured. The conductive planes (21,22) carry processing circuitry (41) and interfacing circuitry (42). By introducing two further connection points (31b,32b), the gaps (23) are divided into first gaps (23a) and second gaps (23b) by the conductive bridges (24) and the antennas (2) can be used in different frequency bands. The conductive planes (21,22) may make an angle with respect to each other, to allow the antennas (2) to be shaped in dependence of device constructions.

The invention relates to a device comprising an antenna for exchanging radio frequency signals with an other device, and also relates to an antenna, and to a method.

Examples of such a device are home theatre devices, surround sound devices, wireless headphone devices, second room wireless audio devices, bio-sensing devices, positioning tracking devices, mobile terminals and wireless interfaces.

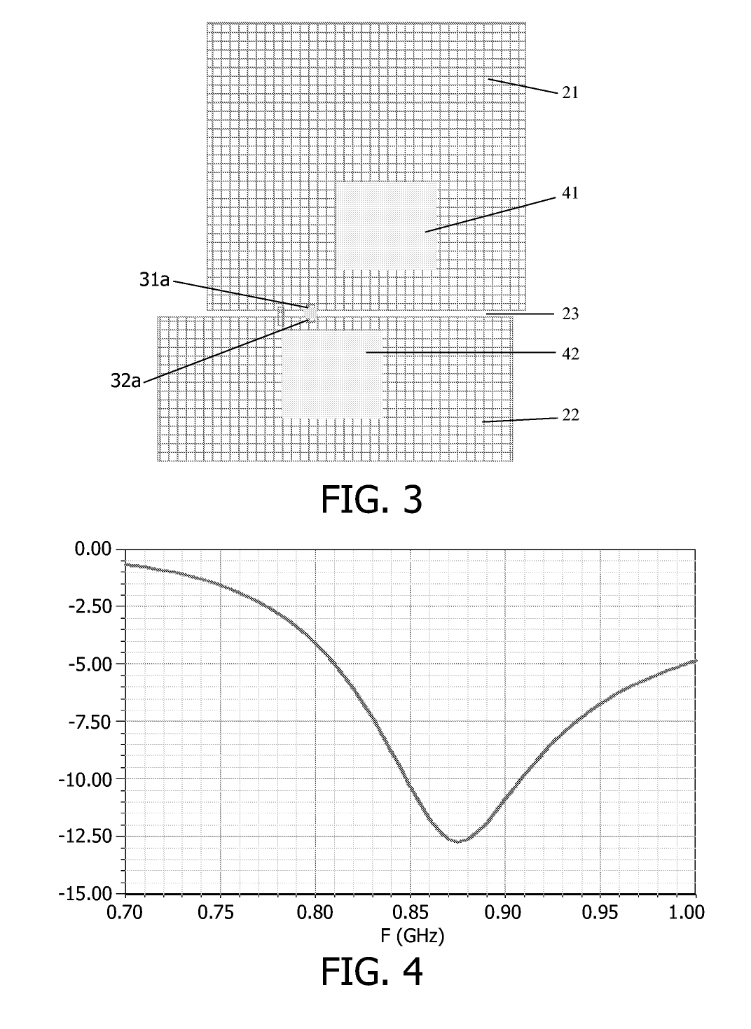

A prior art antenna is known from US 2002/0177416 A1, which discloses in its FIGS. 2 and 3 a ground surface 202 comprising a RF module 206. This RF module 206 comprises RF circuitry 306 mounted on a ground plane 302 incorporating a slot 304 with an open end and a closed end. As disclosed in its FIG. 11, connection points 308,1102 are located at both sides of the slot 304 near the closed end.

The known antenna is disadvantageous, inter alia, owing to the fact that the ground plane operates against the ground surface. Such a ground surface results in a sufficient antenna performance, but is relatively large.

It is an object of the invention, inter alia, to provide a device comprising a relatively small antenna having a sufficient antenna performance.

Furthers objects of the invention are, inter alia, to provide a relatively small antenna having a sufficient antenna performance, and a method for use in combination with a relatively small antenna having a sufficient antenna performance.

The device according to the invention comprises an antenna for exchanging radio frequency signals with an other device, which antenna comprises

a first conductive plane comprising a first connection point;

a second conductive plane comprising a second connection point;

a gap for separating the conductive planes from each other; and

a conductive bridge for coupling the conductive planes to each other; the first and second connection points being located near the gap.

By using two different conductive planes separated from each other by a gap and conductively coupled to each other by a conductive bridge, the antenna has a sufficient antenna performance. This can be derived as follows. In US 2002/0177416 A1, one and the same ground plane incorporates a slot with an open end and a closed end. To be able to mount the RF circuitry on the ground plane, the slot is located asymmetrically in the ground plane. To improve the antenna performance in US 2002/0177416 A1, the ground surface acting as a radiating element had to be introduced. According to the invention, by using the two different conductive planes, it is no longer necessary to introduce such a ground surface.

It should be noted that U.S. Pat. No. 6,407,706 B2 discloses an antenna comprising square elements with wires. These wires form the actual antenna. U.S. Pat. No. 6,768,461 B2 discloses an antenna comprising an elliptical element and a rectangular element separated by a gap. Both elements are not conductively coupled to each other via a conductive bridge. WO 01/59881 A1 discloses an antenna comprising lands separated by gaps. These lands are not conductively coupled to each other via a conductive bridge. These antennas function differently from so-called notch antennas, contrary to the antenna in the device according to the invention, which functions in correspondence with a so-called notch antenna. A so-called notch antenna comprises a conductive plane with a non-conductive slot with connection points, which conductive plane is used for receiving and/or transmitting radio frequency signals and which non-conductive slot with connection points is used for receiving said radio frequency signals from and/or supplying said radio frequency signals to said conductive plane.

The antenna in the device according to the invention is further advantageous in that it is an efficient radiator. The antenna can be used for transmitting as well as for receiving radio frequency signals. The antenna has a sufficient bandwidth, is in fact wideband, is low cost and can easily be manufactured. By locating the connection points closer to the bridge, an antenna impedance is reduced, and vice versa. The conductive bridge for example comprises a wire or a connector etc. By making this conductive bridge a little flexible or by allowing this bridge to be a little flexible, the antenna can handle shocks better.

An embodiment of the device according to the invention is defined by the gap being an air gap and the first and second connection points being located near the gap at a distance of at most a gap width from the gap. The use of an air gap, compared to other non-conductive gaps, increases the bandwidth of the antenna.

An embodiment of the device according to the invention is defined by perimeters of the conductive planes being at least 50% of a wavelength of the radio frequency signals and a gap length being between 10% and 50% of the wavelength of the radio frequency signals and a gap width being at most 20% of the wavelength of the radio frequency signals. This antenna has a good antenna performance. Preferably, the perimeters are each about one wavelength.

An embodiment of the device according to the invention is defined by the first conductive plane further being a carrier for carrying processing circuitry. This processing circuitry for example comprises signal processing circuitry such as radio frequency circuitry and base band circuitry.

An embodiment of the device according to the invention is defined by the second conductive plane further being a carrier for carrying interfacing circuitry. This interfacing circuitry for example comprises user interface circuitry such as volume control circuitry and channel control circuitry.

An embodiment of the device according to the invention is defined by the gap comprising a first gap and a second gap separated from each other by the conductive bridge, the first and second connection points being located near the first gap and the first conductive plane further comprising a further first connection point and the second conductive plane further comprising a further second connection point, the further first and further second connection points being located near the second gap. This allows the antenna to be used in a first mode, in which case the first gap is active, or in a second mode, in which case the second gap is active.

An embodiment of the device according to the invention is defined by the first and second gaps being air gaps and the first and second connection points being located near the first gap at a distance of at most a gap width from the first gap and the further first and further second connection points being located near the second gap at a distance of at most the gap width from the second gap. The use of an air gap, compared to other non-conductive gaps, increases the bandwidth of the antenna.

An embodiment of the device according to the invention is defined by the first gap having a first gap length between 10% and 50% of a first wavelength of the radio frequency signals and the second gap having a second gap length between 10% and 50% of a second wavelength of the radio frequency signals. In the first mode, radio frequency signals are exchanged having a first wavelength, and in the second mode, radio frequency signals are exchanged having a second wavelength.

An embodiment of the device according to the invention is defined by the first wavelength of the radio frequency signals corresponding with a frequency below 1 GHz and the second wavelength of the radio frequency signals corresponding with a frequency above 1 GHz. The first wavelength for example corresponds with a frequency situated between 800 MHz and 950 MHz, and the second wavelength for example corresponds with a frequency at 2.4 GHz.

An embodiment of the device according to the invention is defined by the conductive planes not operating against a ground surface. This allows the antenna to be as compact as possible.

An embodiment of the device according to the invention is defined by the conductive planes forming part of printed circuit boards or other laminate material. This allows the printed circuit board or other laminate material to have a dual function: an antenna function and a mounting function.

An embodiment of the device according to the invention is defined by the conductive planes making an angle with respect to each other, which angle is different from zero degrees and is different from 180 degrees. This allows the antenna to be shaped in dependence of a construction of the device, and improves the omni-directionality of the antenna.

The antenna according to the invention for exchanging radio frequency signals is defined by comprising

a first conductive plane comprising a first connection point;

a second conductive plane comprising a second connection point;

a gap for separating the conductive planes from each other; and

a conductive bridge for coupling the conductive planes to each other;

the first and second connection points being located near the gap.

The method according to the invention for exchanging radio frequency signals is defined by comprising a step of using an antenna, which antenna comprises

a first conductive plane comprising a first connection point;

a second conductive plane comprising a second connection point;

a gap for separating the conductive planes from each other; and

a conductive bridge for coupling the conductive planes to each other;

the first and second connection points being located near the gap.

Embodiments of the antenna according to the invention and of the method according to the invention correspond with the embodiments of the device according to the invention.

The invention is based upon an insight, inter alia, that a prior art antenna uses one ground plane having an asymmetrical slot and requires a relatively large ground surface to be introduced to act as a radiating element, and is based upon a basic idea, inter alia, that two or more different conductive planes separated from each other by one or more gaps and conductively coupled to each other by one or more conductive bridges are to be used for realizing a sufficient antenna performance.

The invention solves the problem, inter alia, to provide a device comprising a relatively small antenna having a sufficient antenna performance, and is advantageous, inter alia, in that the antenna has a good antenna performance. The antenna is an efficient radiator and can be used for transmitting as well as for receiving radio frequency signals. The antenna has a sufficient bandwidth, is in fact wideband, is low cost and can easily be manufactured.

These and other aspects of the invention will be apparent from and elucidated with reference to the embodiments(s) described hereinafter.

In the drawings:

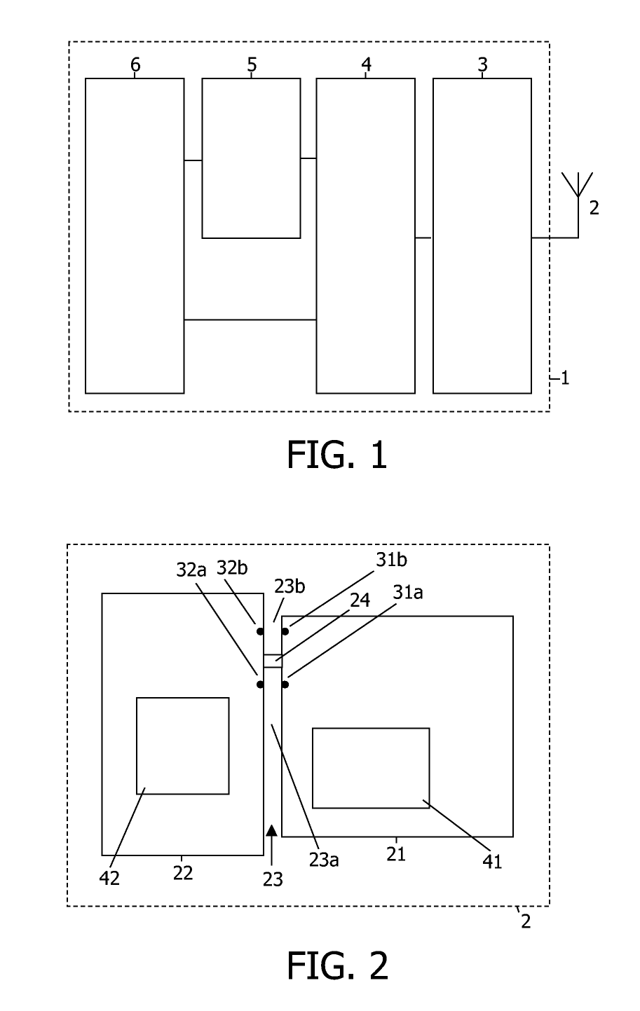

FIG. 1 shows diagrammatically a device according to the invention comprising an antenna according to the invention;

FIG. 2 shows diagrammatically an antenna according to the invention in greater detail;

FIG. 3 shows a top view of an antenna according to the invention with processing circuitry and interfacing circuitry being mounted;

FIG. 4 shows a simulated return loss in planar simulator of an antenna according to the invention;

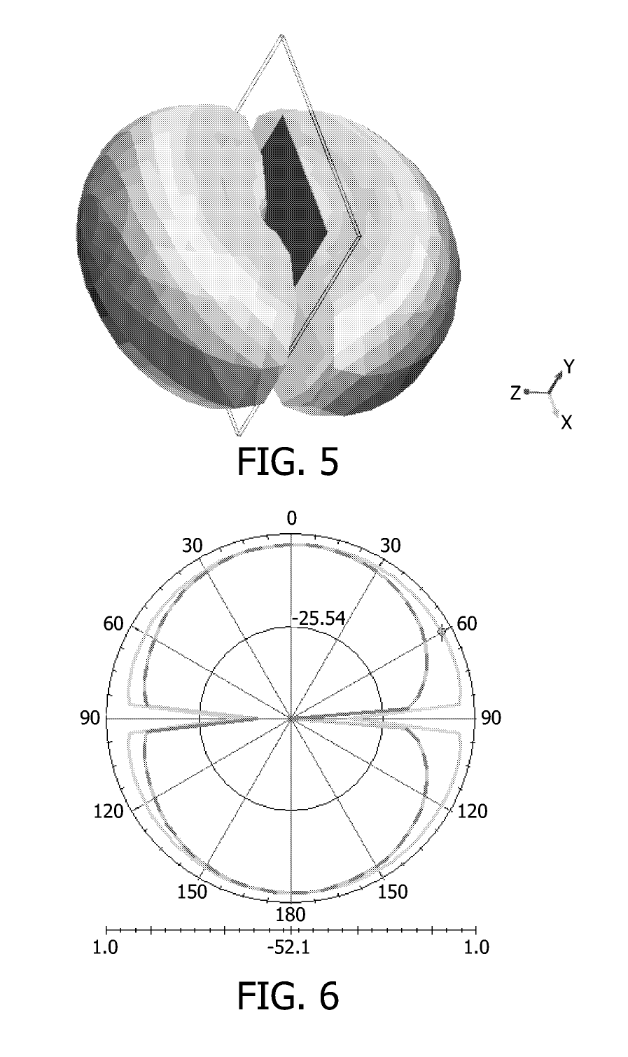

FIG. 5 shows a simulated three-dimensional radiation pattern in planar simulator of an antenna according to the invention; and

FIG. 6 shows a simulated two-dimensional radiation pattern in planar simulator of an antenna according to the invention.

The device 1 according to the invention as shown in FIG. 1 such as for example a home theatre device, a surround sound device, a wireless headphone device, a second room wireless audio device, a bio-sensing device, a positioning tracking device, a mobile terminal or a wireless interface comprises an antenna 2 according to the invention coupled to a radio unit 3. The radio unit 3 is coupled to a digital signal processor 4, which is coupled to a man-machine-interface 6, indirectly via a digital-to-analog converter 5, and directly without any unit being in between.

The antenna 2 according to the invention as shown in FIG. 2 in greater detail comprises a first conductive plane 21 and a second conductive plane 22 separated by a non-conductive gap 23 and conductively coupled to each other via a conductive bridge 24. This conductive bridge 24 separates the gap 23 into a first gap 23a and a second gap 23b. The first conductive plane 21 comprises a first connection point 31a located near the first gap 23a and a further first connection point 31b located near the second gap 23b and the second conductive plane 22 comprises a second connection point 32a located near the first gap 23a and a further second connection point 32b located near the second gap 23b. Processing circuitry 41 is mounted on the first conductive plane 21 and interfacing circuitry 42 is mounted on the second conductive plane 22. One of the (further) connection points 31a,32a (31b,32b) is for example a ground feeding point and an other is for example a signal feeding point.

The gap 23 is for example an air gap. This, compared to other non-conductive gaps, increases the bandwidth of the antenna 2. The first and second connection points 31a,32a are located near the gap 23 at a distance of at most a gap width from the gap 23. The gap width is the distance between the conductive planes 21,22.

To get a good antenna performance, the perimeters of the conductive planes 21,22 are at least 50% of a wavelength of radio frequency signals to be exchanged with an other device not shown. The first gap length of the first gap 23a is between 10% and 50% of the wavelength of the radio frequency signals and the gap width is at most 20% of the wavelength of the radio frequency signals. The first gap length of the first gap 23a is the distance from the conductive bridge 24 to one of the corners of the conductive planes 21,22, which corner comes first when following the first gap 23a from the conductive bridge 24 to the open end of the first gap 23a. Preferably, the perimeters are each about one wavelength and the gap length is about a quarter of the wavelength.

The first conductive plane 21 carries processing circuitry 41 such as for example signal processing circuitry such as radio frequency circuitry (radio unit 3) and base band circuitry (digital signal processor 4 and digital-to-analog converter 5).

The second conductive plane 22 carries interfacing circuitry 42 such as for example user interface circuitry such as volume control circuitry and channel control circuitry (man-machine-interface 6).

The antenna 2 may be operated in a first mode, in which case the first gap 23a and the first and second connection points 31a,32a are active, or in a second mode, in which case the second gap 23b and the further first and further second connection points 31b,32b are active.

The first gap length of the first gap 23a is between 10% and 50% of a first wavelength of the radio frequency signals and the second gap length of the second gap 23b is between 10% and 50% of a second wavelength of the radio frequency signals. The second gap length of the second gap 23b is the distance from the conductive bridge 24 to one of the corners of the conductive planes 21,22, which corner comes first when following the second gap 23b from the conductive bridge 24 to the open end of the second gap 23b. In the first mode, radio frequency signals are exchanged having a first wavelength, and in the second mode, radio frequency signals are exchanged having a second wavelength. The first wavelength of the radio frequency signals corresponds for example with a frequency below 1 GHz such as a frequency situated between 800 MHz and 950 MHz and the second wavelength of the radio frequency signals corresponds for example with a frequency above 1 GHz such as a frequency at 2.4 GHz.

The conductive planes 21,22 do not operate against a ground surface. This allows the antenna 2 to be as compact as possible. The conductive planes 21,22 form part of printed circuit boards or other laminate material. This allows the printed circuit board or other laminate material to have a dual function: an antenna function and a mounting function.

The conductive planes 21,22 may make an angle with respect to each other (for example by giving the conductive bridge a hinge function), which angle is different from zero degrees and is different from 180 degrees. This allows the antenna 2 to be shaped in dependence of a construction of the device 1, and improves the omni-directionality of the antenna 2.

In FIG. 3, a top view of an antenna 2 according to the invention with processing circuitry 41 and interfacing circuitry 42 being mounted is shown. The conductive planes 21,22 are for example FR4 printed boards having for example a 1.6 mm thickness. The first conductive plane 21 is for example 58×58 mm, the second conductive plane 22 is for example 70×32 mm. The processing circuitry 41 is for example 33×24 mm. The ground connection point 31a can be found in the first conductive plane 21. The gap width may be 0.5 mm to 5 mm. The processing circuitry 41 and the interfacing circuitry 42 may be shielded by shields not shown to effectively increase the antenna surface. Such shields are to be conductively coupled to the conductive planes 21,22.

In FIG. 4, a simulated return loss in planar simulator of an antenna 2 according to the invention is shown, after having adapted the antenna assembly with an impedance network. The bandwidth is sufficient to cover all world-wide wireless audio frequency bands.

In FIG. 5, a simulated three-dimensional radiation pattern in planar simulator of an antenna 2 according to the invention is shown, the antenna 2 is acting as a vertical dipole when the air gap is horizontally polarized.

In FIG. 6, a simulated two-dimensional radiation pattern in planar simulator of an antenna 2 according to the invention is shown.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

1-14. (canceled)

15. An antenna for a device for exchanging radio frequency signals with an other device, comprising:
a first conductive plane including a first connection point;
a second conductive plane including a second connection point, wherein the first and second conductive planes are different conductive planes;
a gap for separating the first and second conductive planes from each other; and
a conductive bridge for coupling the first and second conductive planes to each other, the first and second connection points being located near the gap.

16. The antenna according to claim 15, wherein the gap is an air gap, and the first and second connection points are located near the gap at a distance of at most a gap width from the gap.

17. The antenna according to claim 15, wherein perimeters of the first and second conductive planes are at least 50% of a wavelength of the radio frequency signals, and a gap length is between 10% and 50% of the wavelength of the radio frequency signals, and a gap width is at most 20% of the wavelength of the radio frequency signals.

18. The antenna according to claim 15, wherein the first conductive plane is a carrier for carrying processing circuitry.

19. The antenna according to claim 15, wherein the second conductive plane is a carrier for carrying interfacing circuitry.

20. The antenna according to claim 15, wherein the gap includes a first gap and a second gap separated from each other by the conductive bridge, the first and second connection points are located near the first gap, the first conductive plane includes a further first connection point, the second conductive plane includes a further second connection point, the further first and further second connection points being located near the second gap.

21. The antenna according to claim 20, wherein the first and second gaps are air gaps and the first and second connection points are located near the first gap at a distance of at most a gap width from the first gap, and the further first and further second connection points are located near the second gap at a distance of at most the gap width from the second gap.

22. The antenna according to claim 20, wherein the first gap has a first gap length between 10% and 50% of a first wavelength of the radio frequency signals, and the second gap has a second gap length between 10% and 50% of a second wavelength of the radio frequency signals.

23. The antenna according to claim 22, wherein the first wavelength of the radio frequency signals corresponds with a frequency below 1 GHz and the second wavelength of the radio frequency signals corresponds with a frequency above 1 GHz.

24. The antenna according to claim 15, wherein the first and second conductive planes are not operating against a ground surface.

25. The antenna according to claim 15, wherein the first and second conductive planes form part of printed circuit boards or other laminate material.

26. The antenna according to claim 15, wherein the first and second conductive planes make an angle with respect to each other, the angle being different from zero degrees and being different from 180 degrees.

27. A device comprising the antenna as defined in claim 15.
